(19) United States
(12) Patent Application Publication
(10) Pub. No.: US 2010/0291798 A1
(43) Pub. Date: Nov. 18, 2010

(54) Connector

(75) Inventors: Hayato Kondo, Osaka (JP); Yutaka Masumoto, Osaka (JP)

Correspondence Address: Intellectual Property Law Office of David Lathrop, No. 827, 39120 Argonaut Way, Fremont, CA, 94538, US

(73) Assignee: Hosiden Corporation, Osaka (JP)

(21) Appl. No.: 12/770,652

(22) Filed: Apr. 29, 2010

(30) Foreign Application Priority Data
May 15, 2009 (JP) 2009-118251

(51) Int. Cl. H01R 13/648

(52) U.S. Cl. 439/607.08

(57) ABSTRACT

A connector with a structure having a tip of a body holding a first contact set is located in an opening formed by a shell member including a shell and a shield cover. A tip of a body holding a second contact set is located in an opening formed by the shell member, and a plurality of receptacles are integrated, a shield plate is placed between the first contact set and the second contact set in parallel with a direction orthogonal to the longitudinal direction of contacts in the two contact sets to reduce crosstalk between the plurality of receptacles.

### TECHNICAL FIELD

The present invention relates to a connector for electrical connection, and more particularly to a connector with a structure in which a plurality of receptacles engaging with corresponding plugs are integrated.

### BACKGROUND ART

Generally, in connectors used for high-speed transmission of electrical signals, shielding between adjacent transmission paths is preferably performed to prevent the transmission paths from being affected each other. For example, a shield plate for avoiding crosstalk is conventionally placed between adjacent contacts (see Patent literature 1, for example). Patent literature 1: Japanese Patent Application Laid Open No. 2002-231390

### SUMMARY OF THE INVENTION

### Problems to be Solved by the Invention

Connectors having a plurality of receptacles for high-speed transmission integrated are used recently, but crosstalk between the receptacles of this type of connector is not considered sufficiently. No measures for actively preventing crosstalk between the receptacles are taken.

The present invention addresses the above problem with the object of providing a connector that significantly reduces crosstalk between contacts of each receptacle in a connector with a structure in which a plurality of receptacles are integrated.

### Means to Solve the Problems

According to the present invention, in a connector having a plurality of receptacles integrated, each of which has a structure in which the tip of a body holding a contact set is positioned in an opening formed by a shell member, a shield plate is placed between the contact sets in the direction parallel with the longitudinal direction of the contacts.

### EFFECTS OF THE INVENTION

According to the present invention, in a connector having the plurality of receptacles integrated, crosstalk between the contact sets of the plurality of receptacles can be reduced significantly.

### BRIEF DESCRIPTION OF THE DRAWINGS

FIG. 1A is a front elevational view showing the appearance of an embodiment of a connector of the present invention.

FIG. 1B is a side elevational view showing the appearance of the embodiment of the connector of the present invention.

FIG. 1C is a bottom view showing the appearance of the embodiment of the connector of the present invention.

FIG. 2A is an enlarged sectional view showing section E-E in FIG. 1A.

FIG. 2B is an enlarged sectional view showing section F-F in FIG. 1B.

FIG. 3 shows exploded perspective views showing the connector in FIG. 1.

FIG. 4 is a perspective view showing the positions of contact sets and a shield plate.

FIG. 5 is a diagram illustrating how the shield plate is installed.

FIG. 6 is a diagram illustrating how the shield plate is electrically connected to a ground terminal.

### DETAILED DESCRIPTION OF THE INVENTION

An embodiment of the present invention will now be described with reference to the drawings.

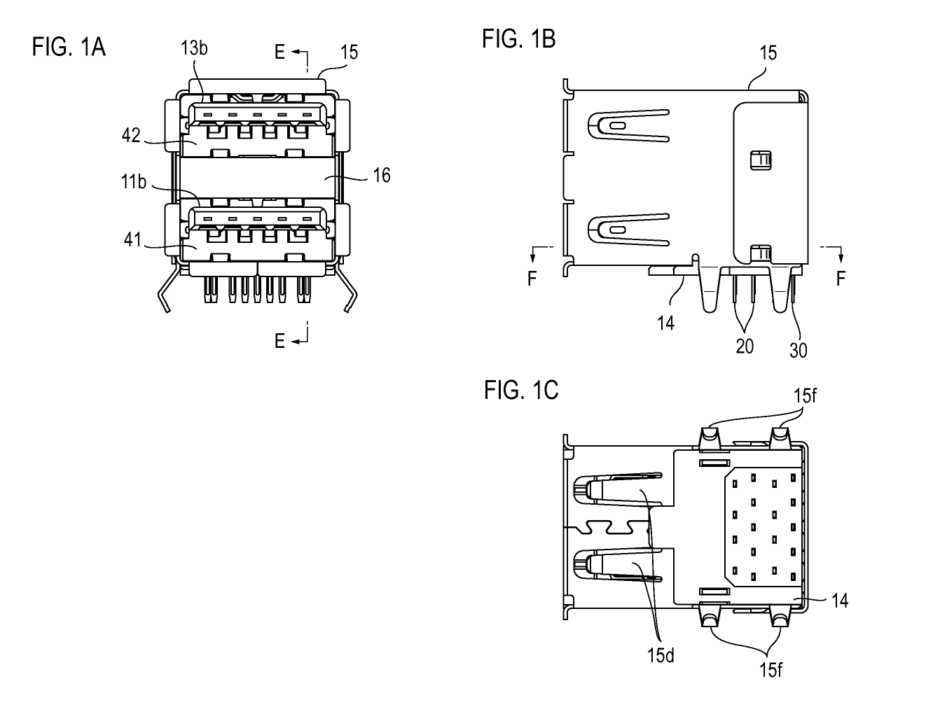

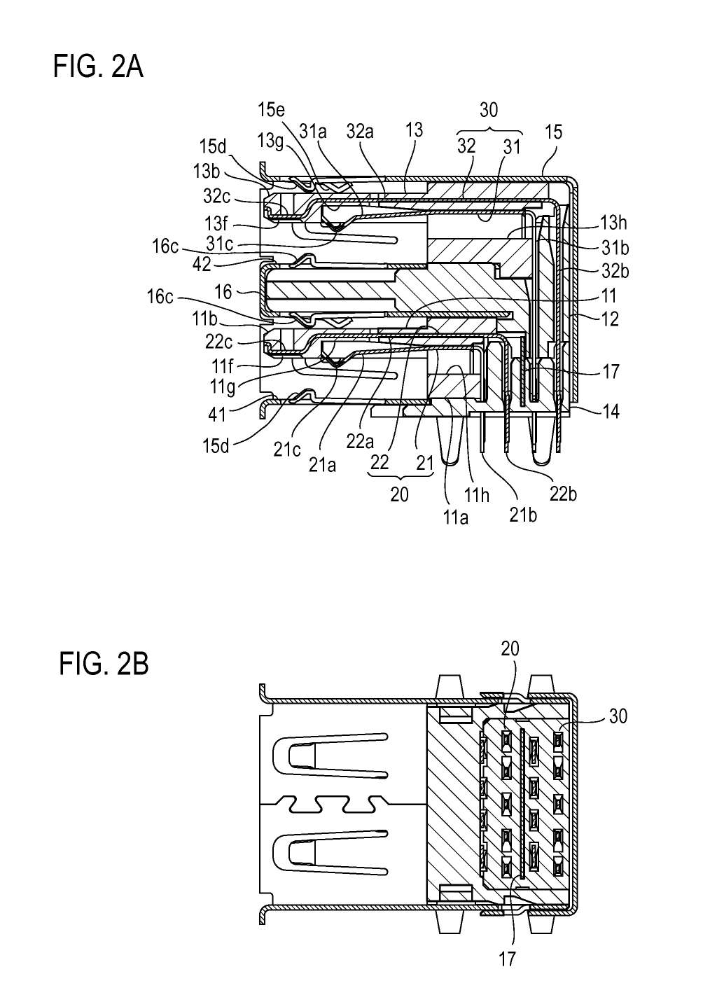

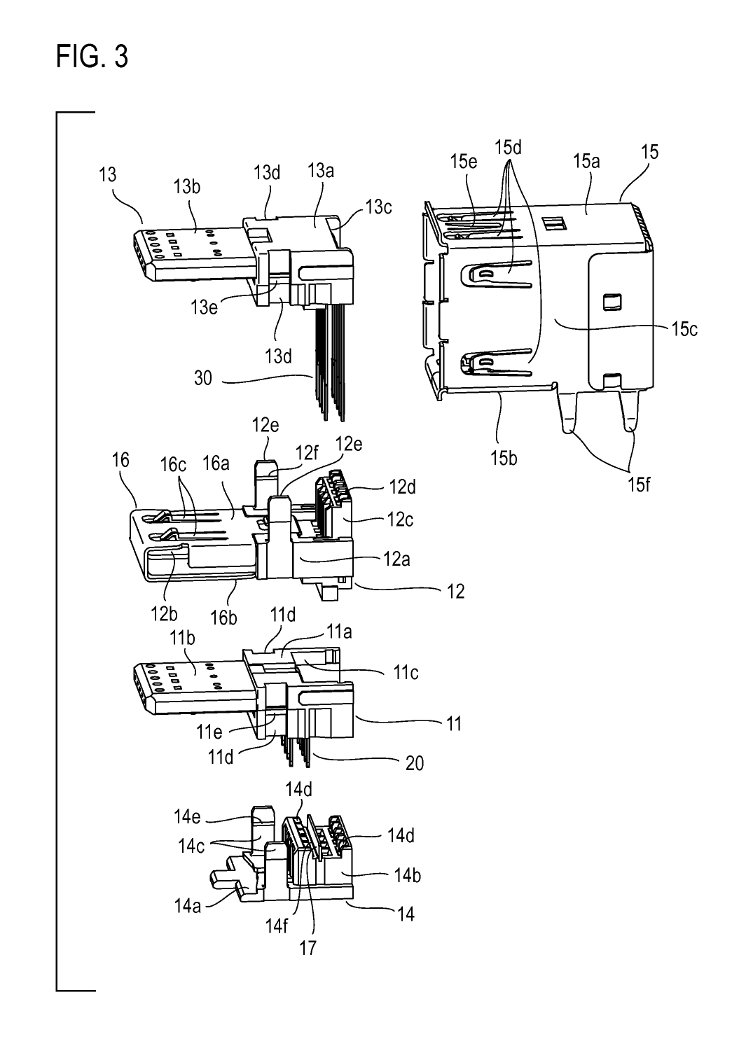

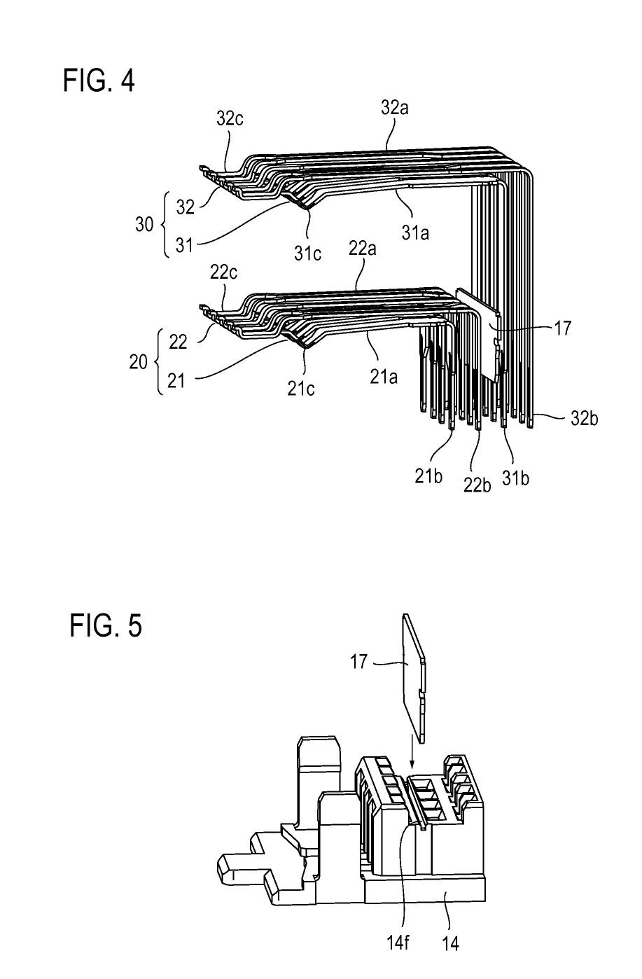

FIGS. 1A, 1B, and 1C show the appearance of an embodiment of a connector of the present invention. FIGS. 2A and 2B show the section of the embodiment of the connector of the present invention. FIG. 3 shows exploded perspective views showing the components of the connector. In this example, the connector includes a first body 11, a second body 12, a third body 13, a spacer 14, a shell 15, a shield cover 16, a shield plate 17, a first contact set 20, and a second contact set 30. In FIG. 3, the first contact set 20, the second contact set 30, the shield cover 16, and the shield plate 17 are installed and held in the first body 11, the third body 13, the second body 12, and the spacer 14, respectively. Of the these components, the positions of the first contact set 20, the second contact set 30, and the shield plate 17 are shown in FIG. 4.

First, the structure of each of the above components will be described.

As shown in FIG. 3, the first body 11 includes a base 11a and a rectangular plate 11b, which is a tongue-shaped projection from the base 11a, and a notch 11c is disposed in the rear wall of the base 11a. Engaging grooves 11d are formed vertically in the side walls of the base 11a, and projections 11e are formed at the bottom of the engaging grooves 11d.

The structure of the third body 13 is similar to that of the first body 11. The third body 13 includes a base 13a and a rectangular plate 13b, which is a tongue-shaped projection from the base 13a. A notch 13c is disposed in the rear wall of the base 13a. Engaging grooves 13d are formed in the side walls of the base 13a, and projections 13e are formed at the bottom of the engaging grooves 13d.

The first contact set 20 held in the first body 11 and the second contact set 30 held in the third body 13 are configured as shown in FIG. 4 and each of these contact sets has nine contacts in two rows. Four contacts 21 in the first row of the first contact set 20, five contacts 22 in the second row of the first contact set 20, four contacts 31 in the first row of the second contact set 30, and five contacts 32 in the second row of the second contact set 30 are bent into an L-shape as shown in FIG. 4. Each of the contacts 21 has a contact part 21a and a vertical part 21b extending orthogonal to the contact part 21a. Similarly, each of the contacts 22 has a contact part 22a and a vertical part 22b. Each of the contacts 31 has a contact part 31a and a vertical part 31b and each of the contacts 32 has a contact part 32a and a vertical part 32b. Contact points 21c, 22c, 31c, and 32c, which make contact with the corresponding plugs, are formed at the ends of the contact parts 21a, 22a, 31a, and 32a.

In this example, the contacts 22 of the first contact set 20 are held in the first body 11 through insertion molding as shown in FIG. 2A and the contact points 22c are located in a concave part 11f formed on the underside of the tip of the rectangular plate 11b and are exposed externally. The contact parts 21a of the contacts 21 are installed and located in a groove 11g formed on the underside of the rectangular plate 11b and the V-shaped contact points 21c project from the underside of the rectangular plate 11b. The contact parts 21a of the contacts 21 pass through holes 11h formed in the base 11a of the first body 11, and the vertical parts 21b of the contacts 21 and the vertical parts 22b of the contacts 22 are located in the notch 11c formed in the base 11a.

The second contact set 30 is held as in the first contact set 20 and the contacts 32 are held in the third body 13 through insertion molding. The contact points 32c of the contacts 32 are located in a concave part 13f formed on the underside of the tip of rectangular plate 13b and are exposed externally. The contact parts 31a of the contacts 31 are installed and located in a groove 13g formed on the underside of the rectangular plate 13b and the V-shaped contact points 31c project from the underside of the rectangular plate 13b. The contact parts 31a of the contacts 31 pass through holes 13h formed in the base 13a of the third body 13 and the vertical parts 31b of the contacts 31 and the vertical parts 32b of the contacts 32 are located in the notch 13c formed in the base 13a.

The second body 12 has the base 12a and a rectangular plate 12b, which is a tongue-shaped projection from the base 12a; a contact alignment unit 12c projecting in the vertical direction is formed at the rear of the base 12a. The contact alignment unit 12c has nine positioning holes 12d, passing through in the vertical direction, that position the vertical parts 31b and 32b of the contacts 31 and the contacts 32 of the second contact set 30. A pair of engaging parts 12e project upward from the side walls of the base 12a and ledges 12f are formed on the inner surfaces of the engaging parts 12e.

The shield cover 16 is attached to the second body 12 so as to cover the upper and lower surfaces of the base 12a of the second body 12 and the upper, lower, and end surfaces of the rectangular plate 12b. A pair of blade springs 16c are formed in each of an upper surface 16a and a lower surface 16b of the shield cover 16 that sandwiches the rectangular plate 12b.

The spacer 14 has a base 14a, a contact alignment unit 14b, which is located at the rear of the base 14a, and a pair of engaging parts 14c. The contact alignment unit 14b has a total of 18 positioning holes 14d, passing through in the vertical direction, that position the vertical parts 31b and 32b of contacts 31 and contacts 32 of the second contact set 30 and the vertical parts 21b and 22b of contacts 21 and contacts 22 of the first contact set 20. The pair of engaging parts 14c project upward from the side walls of the base 14a and ledges 14e are formed on the inner surfaces of the engaging parts 14c.

A slit 14f is formed between the nine positioning holes 14d for the first contact set 20 of the spacer 14 and the nine positioning holes 14d for the second contact set 30 of the spacer 14; the lower half of the shield plate 17 is inserted into the slit 14f as shown in FIG. 5.

The shell 15 is a box-shaped component created by bending a metal plate and has opening on its front side. A pair of blade springs 15d are formed in each of an upper surface 15a, a bottom surface 15b, and side surfaces 15c of the shell 15; a blade spring 15e with its play end pointing in a direction opposite to that of the blade spring 15d is formed between the pair of blade springs 15d in the upper surface 15a. These blade springs 15d and 15e are formed so as to project toward the inside of the shell 15. In addition, a pair of legs 15f project downward from the bottom of each of the side surfaces 15c of the shell 15.

In the above structure, the first body 11, the second body 12, the third body 13, and the spacer 14 are made of insulating resin, and the shell 15, the shield cover 16, and the shield plate 17 are made of highly electrically conductive metal.

The first body 11 holding the first contact set 20, the second body 12 holding the shield cover 16, and the third body 13 holding the second contact set 30 are installed sequentially in the spacer 14 having the shield plate 17 attached; the pair of engaging parts 14c of the spacer 14 caught in the engaging grooves 11d of the first body 11; the ledges 14e are retained by the ledges 11e of the engaging grooves 11d; and similarly the pair of engaging parts 12e of the second body 12 are caught in the engaging grooves 13d of the third body 13. The vertical parts 21b and 22b of the contacts 21 and the contacts 22 of the first contact set 20 pass through the positioning holes 14d of the spacer 14 and project from the bottom of the spacer 14; similarly, the vertical parts 31b and 32b of the contacts 31 and the contacts 32 of the second contact set 30 pass through the positioning holes 12d of the second body 12 and the positioning holes 14d of the spacer 14 sequentially and project from the bottom of the spacer 14. The parts of the contact sets 20 and 30 that project from the bottom of the spacer 14 are used for mounting (soldering) on a substrate.

The shell 15 is installed so as to surround the first, second, and third bodies 11, 12, and 13 and the surfaces of spacer 14 excluding the bottom. As shown in FIG. 1A, the shield cover 16 is placed vertically in the middle of the front opening of the shell 15. The shield cover 16 and the shell 15 in this example function as a shell member; an upper opening 41 and a lower opening 42 are formed by the shell member including the shell 15 and the shield cover 16; the tips (the rectangular plates 11b and 13b) of the first body 11 and the third body 13 holding the contact sets 20 and 30 are located in the upper opening 41 and the lower opening 42, respectively. That is, this example shows a structure in which upper and lower receptacles into which the corresponding plugs are inserted for connection are integrated (in the direction orthogonal to the surface of the substrate).

In the connector with the above structure, the portions of the contact sets 20 and 30 that are close to the openings 41 and 42, that is, the portions close to contact parts 21a, 22a, 31a, and 32a are surrounded by the shell member (including the shell 15 and the shield cover 16), thereby preventing crosstalk between the contact sets 20 and 30 in the portions.

On the other hand, the portions of the contact sets 20 and 30 that are closed to the vertical parts 21b, 22b, 31b, and 32b are not surrounded by the shell member, but the shield plate 17 is placed between the vertical parts 21b and 22b and the vertical parts 31b and 32b in this example in parallel with the longitudinal direction of these vertical parts. Accordingly, crosstalk between the contact sets 20 and 30 in the portions can be well prevented. That is, since the shield plate 17 is placed in this way in addition to the shell member in this example, crosstalk between the contact sets 20 and 30, or crosstalk between the integrated receptacles can be reduced significantly.

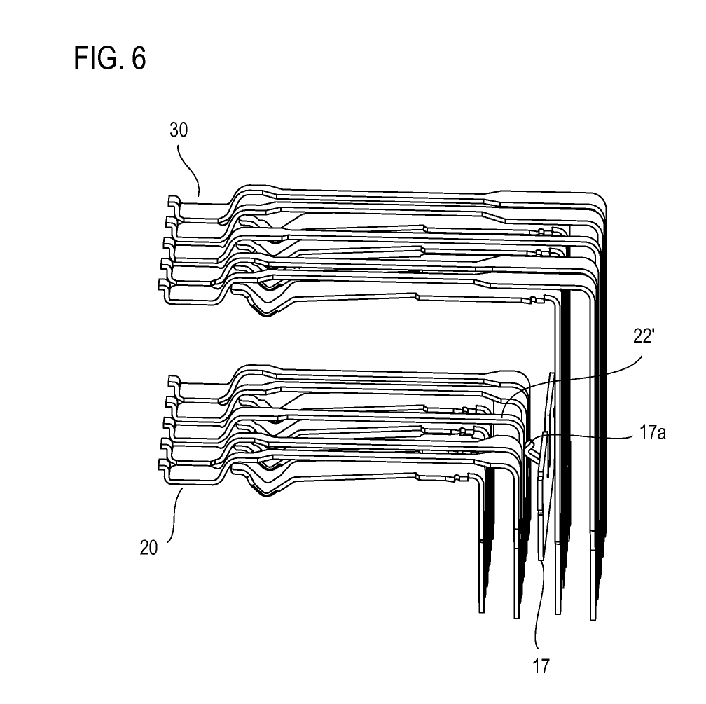

The shield plate 17 is electrically floated to achieve a simple shielding in the above example, but the shield plate 17 may be electrically connected to the ground terminal. FIG. 6 shows a configuration example in this case; in this example, a part of the shield plate 17 is cut and bent obliquely to form a contact piece 17a that makes contact with a ground terminal 22′ of the first contact set 20.

Generally, the shield plate 17 is preferably connected to the ground terminal to eliminate noise. Depending on the state of the ground, however, noise rides on the ground, thereby causing a problem. Whether the shield plate 17 is connected to the ground or floated to achieve simple shielding is determined as appropriate depending on the mounting state of the connector etc.

The connector having the upper and lower receptacles integrated is described in the above example, but the present invention is not limited to this example and it is also applicable to a connector having, for example, three or more receptacles integrated.

What is claimed is:

1. A connector having a plurality of receptacles integrated, each of the plurality of receptacles having a structure in which a tip of a body holding a contact set is located in an opening formed by a shell member, wherein a shield plate is plated between the plurality of contact sets, in parallel with a longitudinal direction of contacts of each of the plurality of contact sets.

2. The connector of claim 1, wherein all of the contacts of each of the plurality of contact sets are mounted in a substrate and the plurality of receptacles are integrated in a direction orthogonal to a surface of the substrate.

3. The connector of claim 2, wherein the portion of each of the plurality of contact sets that is close to the opening is surrounded by the shell member and the shield plate is placed in a portion of each of the plurality of contact sets, the portion being not surrounded by the shell member.

4. The connector of claim 2, wherein each of the contacts of each of the plurality of contact sets has a contact part and a vertical part extending orthogonal to the contact part, the contact part is surrounded by the shell member, and the shield plate is placed in the vertical part.

5. The connector of claim 1, wherein the shield plate is electrically connected to a ground terminal of the plurality of contact sets.

6. The connector of claim 1, wherein the shield plate is electrically floated.
